(19) United States
(12) Patent Application Publication
(10) Pub. No.: US 2013/0040098 A1
(43) Pub. Date: Feb. 14, 2013

(54) BENZOXAZINE STRUCTURES

(71) Applicants: Matthew W. Hooker, Longmont, CO (US); Dana Turse, Broomfield, CO (US); Naseem A. Munshi, Lafayette, CO (US); Jennifer Walsh, Lafayette, CO (US); Michael Tomlinson, Erie, CO (US)

(72) Inventors: Matthew W. Hooker, Longmont, CO (US); Dana Turse, Broomfield, CO (US); Naseem A. Munshi, Lafayette, CO (US); Jennifer Walsh, Lafayette, CO (US); Michael Tomlinson, Erie, CO (US)

(73) Assignee: Composite Technology Development, Inc., Lafayette, CO (US)

(21) Appl. No.: 13/349,977

(22) Filed: Jan. 13, 2012

Related U.S. Application Data
(60) Provisional application No. 61/521,331, filed on Aug. 8, 2011.

(51) Int. Cl. B32B 3/12; B32B 7/02; B32B 3/26; F42B 15/00; D03D 1/00; B32B 1/00; H01Q 1/42; B32B 9/00; D03D 19/00

(52) U.S. Cl. 428/116; 428/704; 428/221; 428/213; 428/318.4; 442/1; 442/181; 428/174; 343/872; 102/374

(57) ABSTRACT

Embodiments of the invention are directed toward benzoxazine composite structures and the application thereof. In some embodiments, a radome can be constructed from a benzoxazine composite structure. A benzoxazine structure can include a low density core with one or two benzoxazine composite face skins. The benzoxazine face skins can include reinforcement materials to provide structural strength. Such radomes and/or benzoxazine structures can be used in various maritime, aircraft, rocket, missile, and/or automobile applications. In particular, radomes can be used to house communication equipment such as antennas and the like.

### CROSS-REFERENCES TO RELATED APPLICATIONS

This is a non-provisional application that claims the benefit of commonly assigned U.S. Provisional Application No. 61/521,331, filed Aug. 8, 2011, entitled “Benzoxazine Structures,” the entirety of which is herein incorporated by reference for all purposes.

### BACKGROUND

Polymer based structures have been used in a number of applications. Polymers can have some favorable properties that make them ideal for radar applications like radomes. Radomes, for example, can be constructed from low dielectric materials that have high environmental performance capabilities. Often radomes are used in harsh climates such as on ships at seas, on airplanes traveling at high speeds, or on wind swept mountains. Radomes should sufficiently protect the radar equipment from the environment, while maintaining stable mechanical performance and radar transmission.

### BRIEF SUMMARY

Embodiments of the invention include benzoxazine structures that can include a benzoxazine face skin and a low density core material. The core material, for example, can be a foam. The benzoxazine face skins, for example, can include a reinforcement material such as fibers, meshes, or particulates as well as a benzoxazine polymer. Such benzoxazine structures can be used in a number of applications such as, for example, radomes.

The following detailed description together with the accompanying drawings will provide a better understanding of the nature and advantages of the present invention.

### BRIEF DESCRIPTION OF THE DRAWINGS

FIG. 1 shows a benzoxazine composite structure according to some embodiments of the invention.

FIG. 2 shows another benzoxazine composite structure according to some embodiments of the invention.

FIG. 3 shows a radome that can be constructed from a benzoxazine composite structure according to some embodiments of the invention.

FIG. 4 shows another radome that can be constructed of a benzoxazine composite structure according to some embodiments of the invention.

FIG. 5 shows a missile that can be constructed partially or completely from benzoxazine materials according to some embodiments of the invention.

### DETAILED DESCRIPTION

Embodiments of the invention include benzoxazine structures that can include a benzoxazine face skin and a low density core material. The core material, for example, can be a foam or honeycomb. The benzoxazine face skins, for example, can include a reinforcement material such as fibers, meshes, or particulates as well as a benzoxazine polymer. Such benzoxazine structures can be used in a number of applications such as, for example, radomes.

As used throughout this disclosure the term “benzoxazine material” is any material that includes benzoxazine. The term “benzoxazine composite material” is a benzoxazine material with some type of reinforcement material. And the term “benzoxazine composite structure” is a structure that includes at least one layer of a benzoxazine composite material and a second layer of another material. Benzoxazine composite structures can include benzoxazine sandwich panels that include two outer layers sandwiching an inner core layer. One or both of the two outer layers can include a benzoxazine material layer, a non-benzoxazine material layer, and/or a benzoxazine composite material.

Some embodiments of the invention employ benzoxazine materials in a number of structural applications that will be described below. Benzoxazine is a bicyclic heterocycle consisting of a benzene ring fused with an oxazine. Benzoxazine materials, for example, can be formed from the reaction product of an amine, a phenol, and formaldehyde.

Benzoxazine materials can be combined or hybridized with any number of materials. A number of materials are listed herein as examples of materials that can be used to hybridize with benzoxazine. But any material can be used whether described herein or not. Benzoxazine can be hybridized with a material based on the specific application to improve the structural, electrical, thermal, mechanical, and/or environmental performance, etc.

Benzoxazine can be combined or hybridized with polymers, cynates (e.g., cynate ester), olifins (e.g., Cyclic Olefin Copolymer), epoxies, polypropylene, etc. Other materials can be used such as Vinyl esters, Bismaleimides, methacrylates, phenolics, POSS, liquid silanes, siloxanes, thermoplastics, thermosets, and/or reactive rubbers. Various fillers may also be used to hybridize, such as nanoclay, core shell rubbers, glass microballoons, ceramic particles or microballoons, phenolic or other polymeric particles or microballoons, fumed silica, wollastonite, and/or duralite.

Benzoxazine materials can exhibit a number of properties that can be useful for various applications such as, for example, flame retardance, high modulus, high glass transition temperature, low curing shrinkage, low water absorption (e.g., less than 10%, 8%, 5%, 3%, 2%, 1% water absorption by weight), low dielectric constant (e.g., at RF frequencies), low dissipation factors (e.g., below 0.05 at RF frequencies, erosion resistivity, shear strength, impact resistance, high temperature resistance, bending resistivity, compressive strength, and/or stable thermal mechanical properties.

Benzoxazine Composite Material

Benzoxazine composite materials are used in various embodiments of the invention. Benzoxazine composite materials generally include a benzoxazine with a reinforcement material such as a fiber, yarn, mesh, fabric, weave, etc. In some embodiments, carbon fibers or metallic fibers can be used. In some embodiments, a metallic mesh or surface etching in a particular orientation or grid pattern can provide frequency-selective surface (FSS) properties.

For purposes of this disclosure, the term “fiber” encompasses a structure that exhibits a length that exceeds the largest cross-sectional dimension (e.g., the diameter for round fibers). Thus, the term “fiber” differs from other structures such as plaques, containers, sheets, films and the like that can be extruded, blow-molded or injection molded. The term “fiber” does encompass, however, structures including monofilament fibers, multi-filament fibers, yarns, tape fibers, and the like.

The term “multi-filament yarn” is intended to encompass a structure that includes at least three filaments that have been individually formed such as via extrusion through a spinneret prior to being brought in proximity to one another to form a single yarn structure that can then be incorporated into a fabric.

High modulus fibers suitable for use in the present invention can generally have a modulus as measured according to ASTM D2256-02, which is incorporated herein by reference, greater than about 8 GPa (100 grams/denier). In one embodiment, the fibers can have a modulus greater than about 10 GPa, for example, greater than about 12 GPa, or greater than about 16 GPa. In addition, the fibers of the present invention can have a high tenacity, for example greater than about 400 MPa (5 grams/denier) in some embodiments as measured according to ASTM D2256-02. In one embodiment, the fibers can have a tenacity greater than about 500 MPa, or greater yet, greater than about 560 MPa (7 grams/denier). The fibers can also have a low density, for example, less than about 1.3 g/cm³, in one embodiment. In another embodiment, the fibers can have a lower density, for instance less than about 1.0 g/cm³

In some embodiments of the invention, benzoxazine composite structures can include reinforcement materials in the form of fibers, yarns, or meshes that can include glass materials, ceramics, polymers, or hybrids thereof. These multiple reinforcement materials can be woven or braided together.

Glass reinforcement materials can include E-glass, S-glass, S2-glass, NE-glass, and/or D-glass. Ceramic reinforcement materials can include Nextel products and/or Al₂O₃ fibers. Other reinforcement materials can include quartz, basalt, thermoplastic hybrids, thermoplastic/glass hybrids (e.g., 940 Innegra S), polypropylene (PP), high molecular weight polypropylene (HMPP), ultra high molecular weight polyethylene (UHMWPE), polyphenylene oxide (PPO), Cyclic Olefin Copolymer (COC), Polyether Imide (PEI), and Polyetheretherketone (PEEK). As another example, Aramid fibers such as Kevlar can also be used.

Any number of processes known in the art can be used to construct a benzoxazine composite material. For example, the pre-impregnation process or the resin transfer molding process may be used.

Benzoxazine Composite Structures

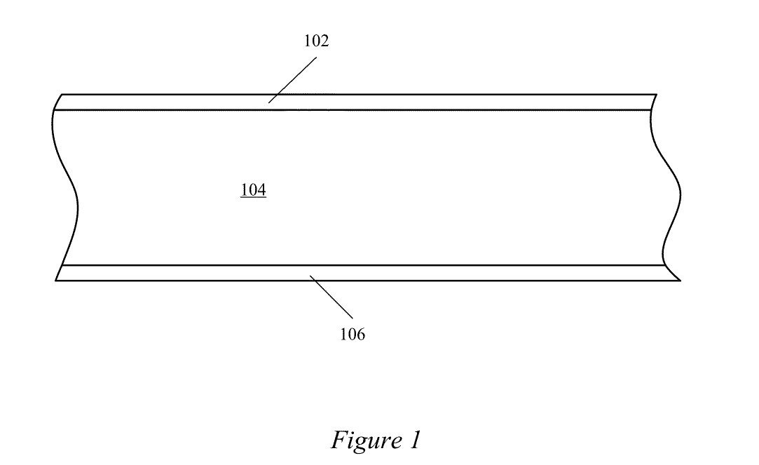

A simple benzoxazine composite structure can include benzoxazine and a reinforcement material. As shown in the cross section in FIG. 1, benzoxazine composite structure 100 includes two benzoxazine layers 102 and 106 (with or without reinforcement material) and core 104 according to one embodiment of the invention. In this embodiment, Benzoxazine composite structure 100 is a sandwich panel. That is, the structure includes two benzoxazine layers 102 and 106 that sandwich core 104. In some embodiments, a sandwich structure can include a benzoxazine layer and a non-benzoxazine layer sandwiching core 104. In some embodiments, benzoxazine layer 102 and/or 106 can be a thin layer and core 104 can be substantially thicker. Various additional layers may also be used.

In some embodiments, a benzoxazine composite structure can include a benzoxazine layer (with or without reinforcement material) and one or more face sheets. A face sheet can be a thin active or passive layer. In FIG. 1, for example, benzoxazine layers 201 and 106 are face sheets to sandwich core 104. Face sheets can have a thickness that is half the thickness sandwich core. In other embodiments, the sandwich core can have a thickness that is at least 2, 5, 10, 15, 20, 30, or 40 times wider than either or both face sheets.

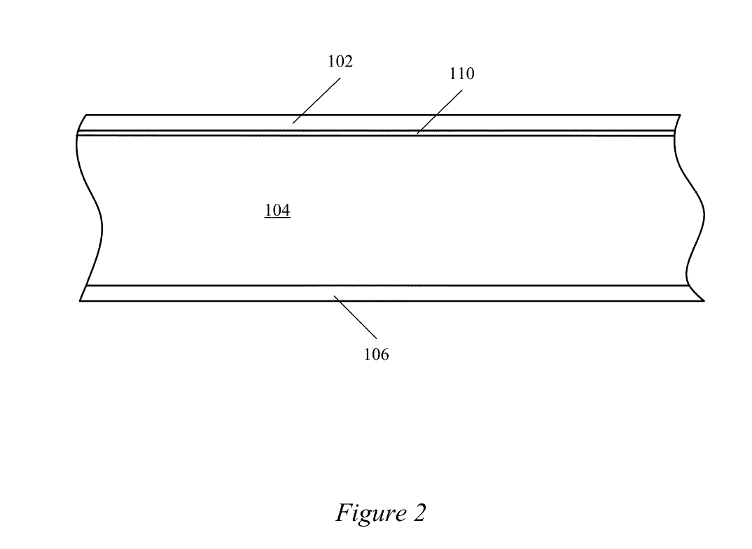

In some embodiments, a benzoxazine composite structure can include a benzoxazine layer (with or without reinforcement material) with a tunable layer. Some embodiments of the invention can be used in radar applications. In such applications an electrically conductive mesh can be embedded within a benzoxazine composite structure to provide frequency filtering (see FIG. 2). The type and/or size of the mesh can vary depending on the frequency or frequencies of radiation sought to be blocked.

Core 104 can be a foam or honeycomb material; for example, a plastic foam or honeycomb material. Core 104 can be a low density thermoplastic such as, for example, polyvinyl chloride (PVC), polyetherimide (PEI), styrene butadiene styrene (SBS), acrylonitrile butadiene styrene (ABS), or chemical combinations thereof. The honeycomb construction can be a fiber reinforced resin shaped to have hexagonally arranged ridges throughout.

Benzoxazine composite structure can be used for any number of applications. In one application, the benzoxazine composite structure can be manufactured into large sheets (e.g., about 5 feet long and/or wide). These sheets can be constructed with any size or dimension. These sheets can then be used to construct various structures. Domes and other structures may also be constructed from a benzoxazine composite structure.

FIG. 2 shows the benzoxazine composite structure shown in FIG. 1 with an additional layer 110. This additional layer can include any number of sublayers. Layer 110 can include a frequency-selective filter. A frequency-selective filter can include a conductive mesh or screen that provides electromagnetic interference protection and/or electro-optical interference protection. In some embodiments, the frequency-selective filter can be a layered material. In some embodiments, the frequency-selective filter can be a mesh material. In some embodiments, the frequency-selective filter can include a metallic grid deposited on a polymer substrate. In some embodiments, the frequency-selective filter can include strip grating filters, mesh filters, and/or cross-mesh filters. The frequencies filtered by frequency-selective filter can depend on a number of physical characteristics of the frequency-selective filter, for example, the thickness of the frequency-selective filter, the aperture size of the material or surface, the materials used, the substrate, etc.

For example, the aperture size or grid line width of a metallic mesh layer can control the frequency response. Various types of frequency-selective filters can be used including meshes and/or semiconductors. The embodiments of the invention are not limited by use of a frequency-selective filter let alone use of a specific frequency-selective filter. A tunable frequency-selective filter can be used. Moreover, metamaterials can be used with the frequency-selective filter.

In some embodiments of the invention, a frequency-selective filter can include a semiconductor layer (e.g., GaN, GaP, GaAs, SiC, Si, MgF₂, ZnS) or a polymer layer with a frequency-selective surface (e.g., a metallic layer) etched within the semiconductor layer. The frequency-selective surface can be etched, for example, using a chemical etching technique, ablated using a laser, or any other technique.

Radomes

In some embodiments of the invention, benzoxazine composite structures can form the structural elements of a radome. A radome is a structural, weatherproof enclosure that protects communication equipment such as a microwave antenna, a radar antenna, a GPS antenna, etc. The design constraints for a radome can vary depending on the application. And radomes can be used in various applications including ground-based, air-based, and marine-based applications. Moreover radomes can be used in mobile and stationary applications. A radome can be constructed of material that minimally attenuates the electromagnetic signal transmitted or received by the antenna. In other words, the radome is largely transparent to radar or radio waves. Radomes protect the antenna surfaces from the environment (e.g., wind, rain, ice, sand, and ultraviolet rays) and/or conceal antenna electronic equipment from public view. They also protect nearby personnel from being accidentally struck by quickly-rotating antennas.

Radomes can be used in terrestrial, space, flight, and/or oceanic application. Radomes can be constructed in several shapes, for example, spherical, polyhedron, geodesic, dome, planar, etc. depending upon the particular application. Various construction techniques can be used to build a radome from Benzoxazine composite structures.

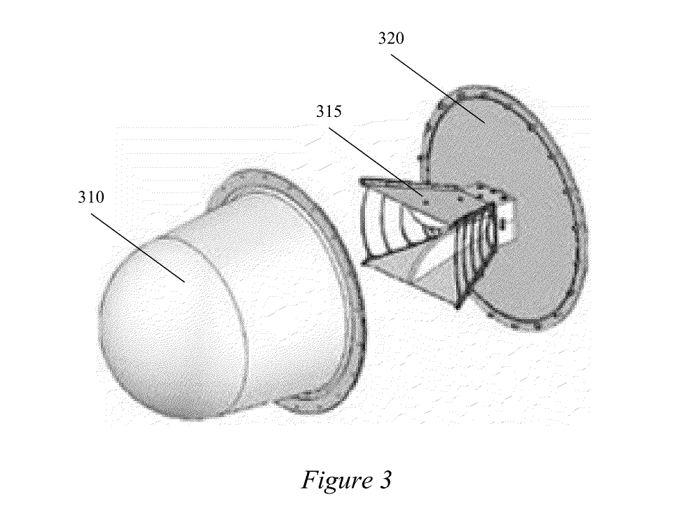

For example, a radome can be formed during manufacturing of the benzoxazine composite structure in the shape of the radome. FIG. 3 shows radome 310 that can be coupled with base plate 320 and covers antenna 315. Radome 310 has a cylindrical body with a half dome top. The cylindrical body can be formed in a cylinder from a benzoxazine composite structure. Similarly, the half dome top can likewise be formed from a benzoxazine composite structure. These structures can be formed in a mold and shaped during construction.

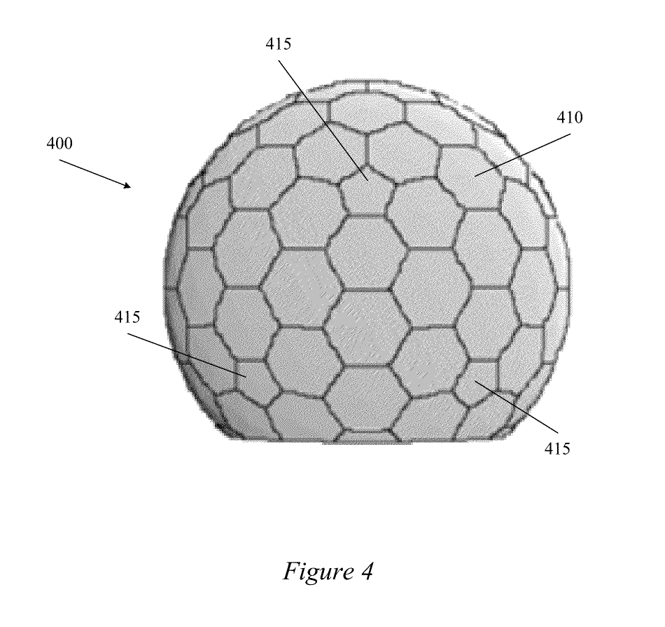

For example, benzoxazine composite structures can be formed in flat or non-flat panels of various sizes and/or shapes. A radome can be constructed from a number of these panels. Large radomes in particular may be constructed from a number of smaller panels. For example, radome 400 shown in FIG. 4 can be constructed from a plurality of flat hexagonal panels 410 and a plurality of flat pentagonal panels 415. Radome 400 generally comprises a soccer ball construction. Various other panel geometries may be used. Panels may be used to construct other structures and/or to create different shaped structures. In some embodiments, these panels can be flat panels and/or used as a flat panel. And flat panels can be used to form radomes with a shape like radome 400 and/or radomes with shapes like geodesic or other polyhedron structures.

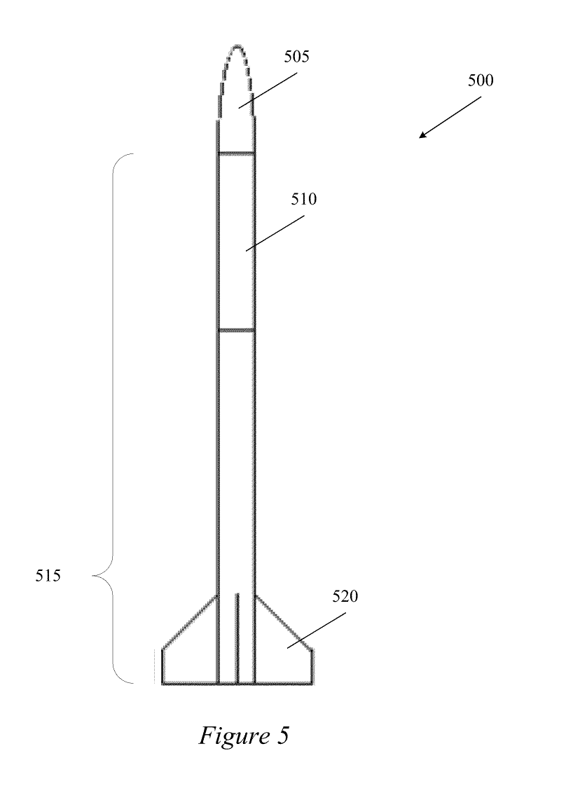

Benzoxazine composite structures can also be used to construct missile radomes. FIG. 5 shows missile 500 with nozzle 505, fuselages 515 and fins 520. Benzoxazine composite structures can be used to construct any or all parts of missile 500. For example, nozzle 505 can house radar equipment and can be constructed from benzoxazine composite structures. Fuselage portion 510 or all of fuselage 515 can also be constructed from benzoxazine composite structures.

Composite structures are easy to design and build into any shape. Various processes can be used to lay the various layers that make up the composite structures described herein. For example, benzoxazine composite structures can be laid up using pre-preg, autoclave molding, co-curing, compression molding, hand lay-up, vacuum assisted resin transfer molding (VARTM), vacuum bag molding, molding, etc. Composite material layers can be laid up in any shape or size as needed. For example, radomes can have any shape such as geodesic, polyhedron, globe, etc.

Various other structures can be constructed from benzoxazine composite structures. For example, in ships all or parts of the hull, decks, quarters, top deck structures, etc. can be constructed from benzoxazine composite structures. Moreover, any structure that is commonly constructed from metal can be replaced with benzoxazine composite structures. In some embodiments, such structures can act as radomes while performing their structural functions. In aircraft, the nozzle, fuselage, wings, tails, fins, etc. can be constructed using benzoxazine composite structures. In some embodiments, such aircraft components can act as radomes while performing their structural functions.

Thus, although the invention has been described with respect to specific embodiments, it will be appreciated that the invention is intended to cover all modifications and equivalents within the scope of the following claims.

What is claimed is:

1. A benzoxazine composite structure comprising:
a first layer comprising benzoxazine;
a core layer disposed on the first layer; and
a second layer disposed on the core.

2. The benzoxazine composite structure according to claim 1, wherein the second layer comprises benzoxazine.

3. The benzoxazine composite structure according to claim 1, wherein the first layer further comprises a reinforcement material.

4. The benzoxazine composite structure according to claim 3, wherein the reinforcement material comprises fiber, yarn, mesh, fabric, or weave.

5. The benzoxazine composite structure according to claim 1, wherein the core has a thickness at least??? 10 times greater than the thickness of the first layer.

6. The benzoxazine composite structure according to claim 1, wherein the core comprises a foam.

7. The benzoxazine composite structure according to claim 1, further comprising a frequency-selective filter disposed between the core and either the first layer or the second layer.

8. The benzoxazine composite structure according to claim 1, wherein the benzoxazine composite structure has less than 1 percent water absorption by weight.

9. A radome comprising:
a communication device; and
a housing within which the radar device is disposed, the housing comprising a benzoxazine layer and a core layer.

10. The radome according to claim 9, wherein the housing further comprises a second benzoxazine layer.

11. The radome according to claim 9, wherein the benzoxazine layer further comprises a reinforcement material.

12. The radome according to claim 9, wherein the housing further comprises a frequency-selective filter.

13. The radome according to claim 9, wherein the housing has less than 1 percent water absorption by weight.

14. The radome according to claim 9, wherein the housing comprises a polyhedron.

15. A composite structure comprising:
a first face skin; and
a foam or honeycomb core,
wherein either or both the first face skin and the core comprise a material having less than 1 percent water absorption by weight.

16. The composite structure according to claim 15, further comprising a second face skin, wherein the first face skin and the second face skin are disposed on opposite sides of the core.

17. The composite structure according to claim 15, wherein either or both the first face skin and the foam or honeycomb core comprise benzoxazine.

18. The composite structure according to claim 15, wherein the composite structure is dome shaped.

19. The composite structure according to claim 15, wherein the composite structure is a flat panel.

20. The composite structure according to claim 15, wherein the composite structure forms a housing for communication equipment.

21. The composite structure according to claim 15, wherein the composite structure is coupled with an aircraft, rocket, boat, sea craft, or automobile.

22. A rocket comprising:
a nozzle; and
a fuselage coupled with the nozzle,
wherein either or both the nozzle and the fuselage comprise a benzoxazine composite structure.

23. The rocket according to claim 22, further comprising communication equipment disposed within either or both the fuselage or the nozzle.
